(19) United States
(12) Patent Application Publication
(10) Pub. No.: US 2003/0172148 A1
(43) Pub. Date: Sep. 11, 2003

(54) Printing system with expanded user assistance capabilities

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/032,680

(22) Filed: Oct. 23, 2001

(51) Int. Cl. G06F 15/16

(52) U.S. Cl. 709/224; 358/1.15; 709/217

(57) ABSTRACT

A computing system that includes a personal computer and a printer is described. The personal computer allows a user to select a document to be printed and to download Web content provided by the printer. The Web content enables the personal computer to print the document in response to user input. The Web content further enables the personal computer to detect if the printer encounters an alert condition while printing the document. In response to detecting the alert condition, the computer displays a hyperlink. Selecting the hyperlink initiates a performance of the computer of a specified function for assisting the user in resolving the alert condition. The administrator can define the hyperlinks.

### BACKGROUND

Printing devices are often configured to alert a user when certain conditions are encountered. For ease of discussion, such a condition may generally be referred to herein as an “alert condition”. For example, printers are often configured to alert a user when a paper jam occurs or when a consumable item (e.g., print media, toner, ink, etc) should be replenished. Thus, a paper jam, out of paper condition, low toner condition, and low ink condition are all examples of “alert conditions”.

Printing devices often provide some sort of help mechanism for notifying a user that an alert condition exists and to provide the user with assistance in resolving the condition. For example, some printing devices provide a local display panel that is used to indicate when certain alert conditions occur. The indication may be a number associated with the alert condition. The display panel may also be used to provide information that can be used to resolve the condition.

In the case of a paper jam condition, for example, a printing device may be configured to cause its local display panel to display an indication that such an event has been detected. The printing device may also display a procedure the user can follow to clear the paper jam.

Prior art help mechanisms (such as local display panels) have limited capability. It would be desirable to provide help mechanisms that offer the user more information and that can provide the user with greater assistance.

### SUMMARY

According to one embodiment, the invention provides a computer implemented method. The method may include, for example, detecting that a printer has encountered an alert condition; and in response to detecting the alert condition, displaying a user selectable object (such as a web page hyperlink). The purpose of the object is for initiating a performance of a specified function for assisting the user in resolving the alert condition.

According to another embodiment, the invention provides a server. The server may include, for example, apparatus for receiving a request from a client and apparatus for responding to the request by transmitting a program of instructions to the client (such as a web page). The program enables the client to: (i) initiate the printing of a document by a printer; (ii) detect if the printer encounters an alert condition while printing a document; and (iii) if an alert condition is detected, display a selectable object for initiating a performance by the client of a specified function. In some implementations, the printer functions as the server.

According to another embodiment, the invention provides computer readable medium embodying a program of instructions for causing a computer to perform method steps. The method steps may include, for example, detecting if the printer encounters an alert condition while printing a document. The method steps may also include displaying a hyperlink referring to a Web object (e.g., a Web page or other type of Web file) for assisting a user in resolving the particular type of alert condition detected.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A and FIG. 1B is a block diagram of a computing system that incorporates an embodiment of the invention;

FIG. 2 is a flow diagram illustrating how a user of a PC in the system can create a job document;

FIG. 3 is a flow diagram illustrating the operation of the PC to request and run PS Web content;

FIG. 4A and FIG. 4B is a flow diagram illustrating the operation of the PC under the direction of the PS Web content;

FIG. 5 provides an example of a GUI that may be displayed by the PC while operating under the direction of the Web content;

FIG. 6 provides an example of a help page;

FIG. 7 is a flow diagram illustrating how a system administrator can request HLS Web content; and

FIG. 8 is a flow diagram illustrating how a system administrator can interact with the HLS Web content to define a set of help links.

### DESCRIPTION

Computers (e.g., personal computers, personal digital assistants (PDA), workstations, etc) often provide a user with a graphical user interface (GUI). The user can interact with the GUI in order to cause the computer to perform various functions. GUI's often include selectable objects (e.g., an icon, a hyperlink, etc) that a user can select in order to initiate a performance by the computer of a specified function. In some computers, a user can select such an object by use of a pointer device (e.g., a mouse), pressing an appropriate key, voice activation, etc.

As indicated above, an example of a selectable object for initiating a performance of a specified computer function is a hyperlink. A hyperlink is often configured to retrieve a particular Web page. For example, assume that a computer is presently displaying (within a Web browser) a Web page. The Web page includes a hyperlink that refers to another Web page (target page) that is located on a remote server. When a user selects the hyperlink, this causes the computer to retrieve the target page from the remote server and to display the target page to the user.

A hyperlink may be configured to initiate a number of other computer functions. For example, a hyperlink may be configured to facilitate the transmission of an e-mail message to a particular e-mail address.

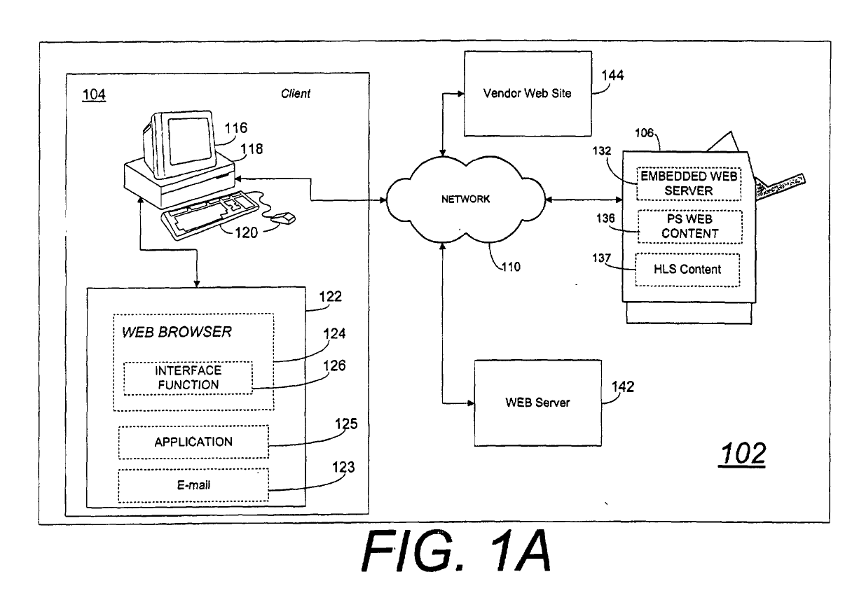

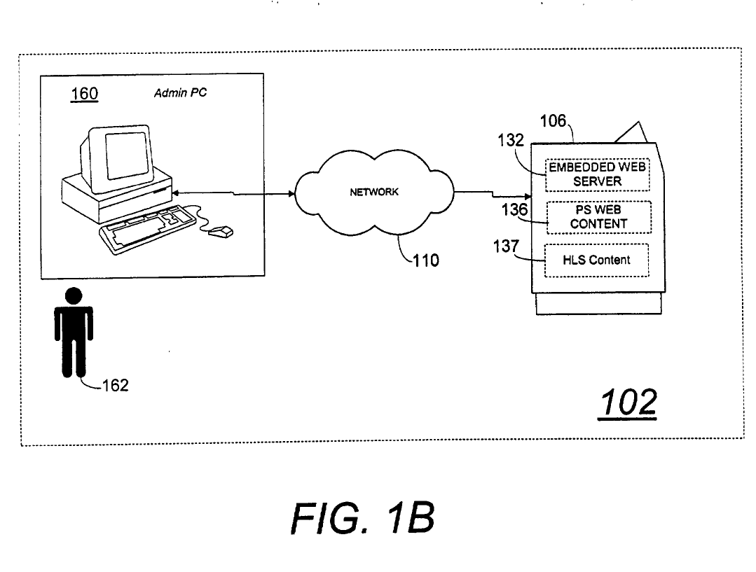

As shown in FIG. 1A, for purposes of illustration, the invention is embodied in a novel computing system 102. The computing system 102 includes a (client 104, a printer 106, a Web server 142 and a vendor Web site 144 all connected to a network 110. In this embodiment, the client 104 is a personal computer. The network 110 may represent, for example, an intranet, a series of networks, the Public Internet, a wireless network(s), etc., or some combination thereof.

As will be discussed in greater detail, the Web server 142 can serve certain Web pages upon receiving an appropriate request that are addressed to a specific URL. The URL will be referred to as URL “A”. Additionally, the vendor Web site 144 includes resources that allow users to make online purchases of various items (such as toner cartridges, ink cartridges, etc) over the network 110.

FIG. 1B illustrates additional elements of the computing system 102. Referring briefly to FIG. 1B, the computing system 102 includes a second PC (admin PC) 160. As is discussed in greater detail below, a system administrator 162 makes use of the admin PC 160 to manage certain aspects of the printer 106. Users can also contact the system administrator 162 (via, for example, e-mail) in order to resolve certain alert conditions that may be encountered by the printer 106.

Referring again to FIG. 1A, in this embodiment, the client 104 runs a local operating system, such as a version of Windows or Windows NT. In order for a user to access the client 104, the user first logs on. This involves the user establishing his/her online identity by inputting a user name and a password. For ease of discussion, a user presently logged into the client 104 may be referred to as the “active user”.

In the present embodiment, there exists a special classification of electronic documents. Documents that fall into this classification are referred to herein as “job documents”. Each job document is linked to a unique user's online identity. A job document that is linked to a particular user's online, identity may be referred to as being that user's “personal” job document.

As will be seen below, the user's personal job document is the document that can be accessed by certain Web based services (such as the Web based printing service described below) when the user is presently the active user.

As shown, the client 104 includes a display monitor 116, a processing unit 118, user input devices 120 and a memory 122. Stored in the memory 122 are an e-mail application 123, a Web Browser 124, and a word processing application 125. The processing unit 118 can retrieve and execute these three applications upon receiving an appropriate request from the user. The Web Browser 124 enables the client 104 to run “Web content” and to function as a Web client in the system 102. As used herein, the phrase “Web content” refers to a program of computer readable instructions that may be executed by a Web Browser. Thus, for example, Web content may be a set of instructions written in any of the following languages (the following is a non-exhaustive list): HTML, Java, JavaScript, C-Sharp code, etc or some combination thereof. Web content may also be written in others languages and even in languages yet to be developed.

The Web browser 124 includes a program interface function (PI function) 126. Web content running in the browser 124 can call the PI function 126 in order to access the active user's personal job document.

It is noted that the call to invoke the PI function 126 is device independent and is defined by a standard. For ease of discussion the call to invoke the PI function 126 may be referred to herein as the “get_job_doc” call. The standard that defines the call may be referred to herein as the “Web Imaging” standard.

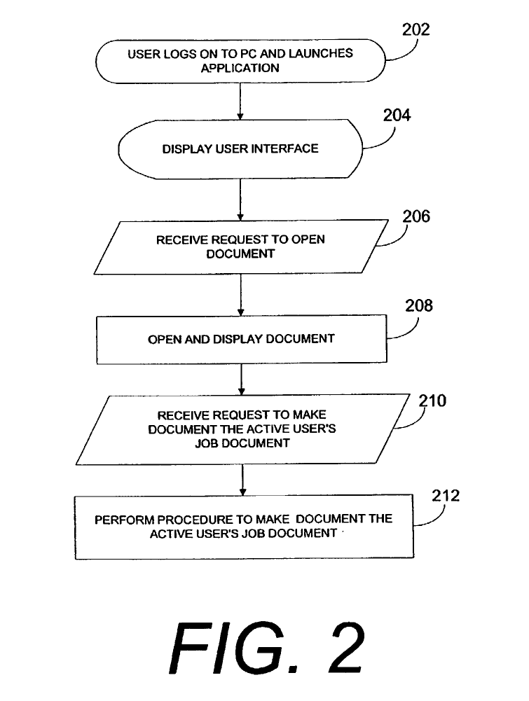

To illustrate the operation of the PI function 126 consider the following example. Assume user “A” designates document “A” to be his/her personal job document. User “B” designates document “B” to be his/her personal job document. Under these conditions, when user “A” is the active user, Web content will access document A by calling the PI function 126. When, however, user “B” is the active user, Web content will access document “B” by calling the PI function 126. It is noted that one way for a user to designate a document to be his/her personal job document is by use of the word processing application 125. FIG. 2 is a flow diagram illustrating this functionality.

Referring now to FIG. 2, a user is assumed to log on to the client 104 and to then launch the application 125 (Step 202). Upon being launched, the application 125 operates to display an initial graphical user interface (step 204). The graphical user interface provides various menus and options. A user can interact with the graphical user interface to create a new document or open an existing document. The graphical user interface further allows a user to input a request to make the document, presently open in the application 125, the user's personal job document.

At step 206, the application 125 is assumed to receive a user request to open a particular document. At step 208, the application 125 responds to the request by opening and displaying the document.

At step 210, the user inputs a request to make the open document his/her personal job document. In response to this user request, the application 125 follows a pre-determined procedure to make the document the user's personal job document (step 212). This may involve configuring the client 104 so that the PI function 126 (which has direct or indirect access to the document) will operate to link Web content to the presently open document whenever the present user is the active user.

It is noted that certain aspects of the procedure followed in step 212 may be governed by the Web imaging standard mentioned above. This standard may specify the formatting of job documents. The standard, for example, may specify that all job documents be filed in a (portable document file) PDF format. Thus, step 212 may involve converting the presently open document into a pre-determined file format.

Other aspects of the procedure, however, may be governed by user preferences (e.g., the storage location of the job document). It is contemplated, for example, that the user may be given the option to store his/her personal job document locally or in a remote location. If the user's personal job document is being stored by a remote system, step 212 may involve configuring the remote system and the PI function 126 to operate cooperatively to link Web content running in the browser 126 to the active user's personal job document when the Web content calls the PI function 126.

Turning again to FIG. 1A, it is first noted that the printer 106 is operable to print a print job received over the network 110. While the printer 106 is printing a document, it is possible that the printer 106 may encounter various types of “alert conditions”.

As shown, the printer 106 includes an embedded Web Server (printer Server) 132. The printer server 132 can serve two programs to requesting Web clients over the network 110. Each of the two programs is assigned a unique URL. The first program is designated “print service” (PS) Web content 136. The second program is designated “Help link Set” (HLS) Web content 137.

As will be discussed in greater detail below, the PS Web content 136 can enable a client to print a document. The PS Web content 136 issues the “get_job doc” call to access a document to print. Thus, the PS Web content 136 enables the client 104 to print the user's personal job document. The system administrator 162 can use the HLS Web content 137 to configure certain aspects of the PS Web content 136.

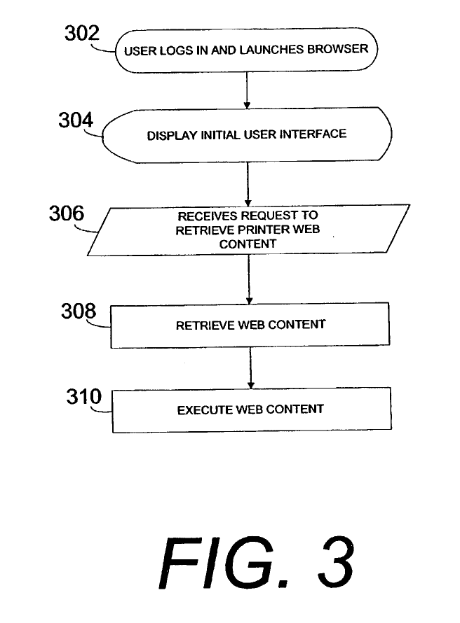

FIG. 3-5 are flow diagrams illustrating how a user of the client 104 can make use of the printing service provided by the printer 106. It will be assumed in the following discussion that the user has previously selected a document to be his/her personal job document.

Turning first to FIG. 3, the user logs into the client 104 and launches the Web Browser 124 (step 302). Upon being launched, the Web Browser 124 displays an initial graphical user interface (step 304).

The user can interact with the graphical user interface to request the PS Web content 136. The Browser 124 receives this user request at step 306. In response, the Browser 124 retrieves the PS Web content 136 by sending an appropriate request to the printer 106 (step 308). At step 310, the Web Browser 124 executes the PS Web content 136.

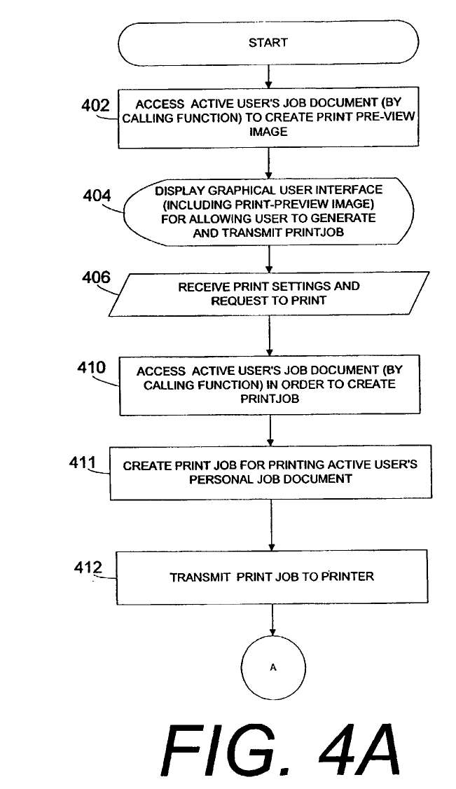

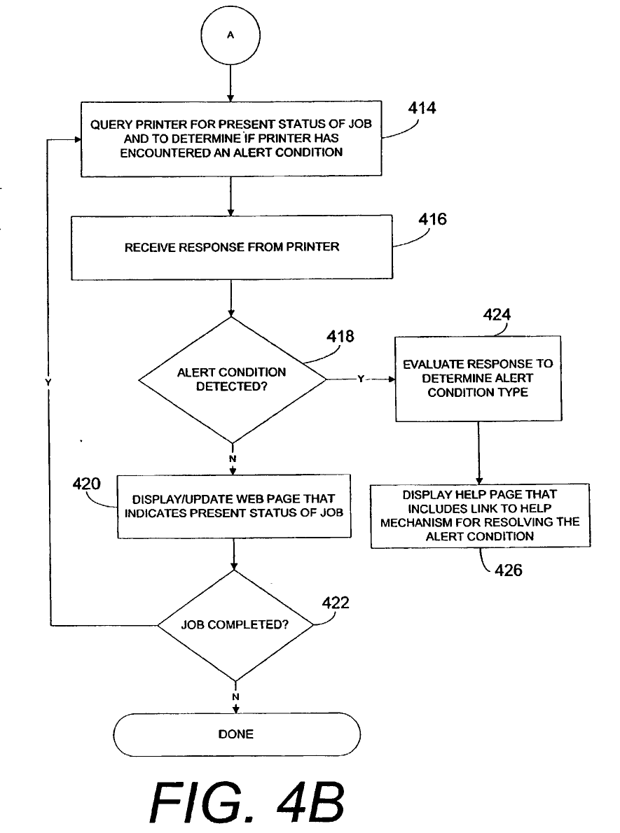

FIG. 4 is a flow diagram illustrating the operation of the PS Web content 136 at step 310. Turning now to FIG. 4, the PS Web content 136 accesses the active user's personal job document by calling the PI function 126 (step 402).

Next, the PS Web content 136 operates to display a graphical user interface (GUI) that allows the user to select various printing options that are offered by the printer 106 (step 404). Additionally, the GUI includes a print-preview image of the user's personal job document. The print-preview image is based upon the imaging information received at step 402.

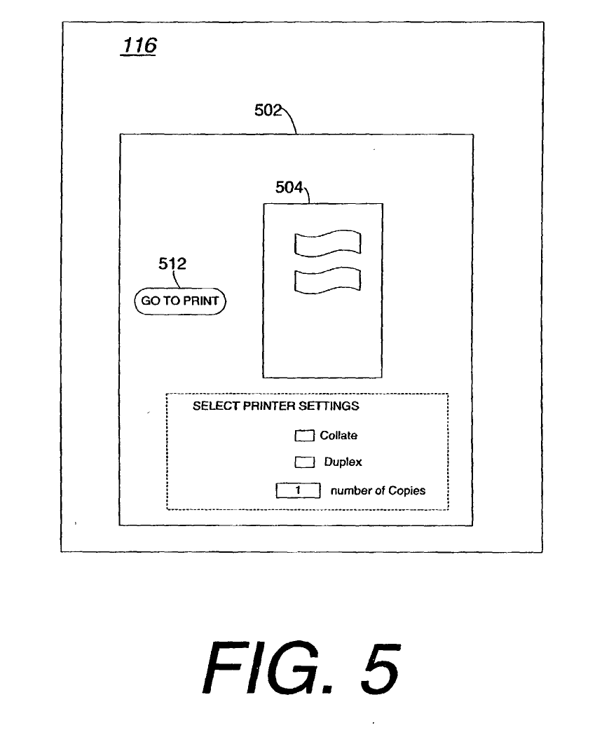

FIG. 5 provides an example of a GUI 502 that may be displayed at step 404 assuming the printer 106 offers document collation, duplex printing and multi-copy printing. In this example, the GUI 502 is a single Web page. As shown, the GUI 502 also allows the user to select various print options. For example, the GUI 502 allows the user to select a document collation option and a duplex printing option. In addition, the user can enter the number of copies he/she wishes to print.

The GUI 502 also includes a print preview image 504. The print preview image 504 provides a visual representation of how the user's personal job document will be printed using the printer 106. The print preview image 504 is based upon the imaging information received at step 402.

After the user has set his/her desired print settings, the user can then request his/her personal job document be printed by selecting the “go to print” button 512.

Referring again to FIG. 4, it is assumed that the user interacts with the GUI displayed at step 404 in order to select his/her desired print settings and to request the active user's personal job document be printed. The client 104 receives this user input at step 406.

In response to this user input, the PS Web content 136 accesses the user's personal job document again by calling the PI function 126 (step 410). The PS Web content 136 uses the imaging information received at step 410 to create a print job (step 411). The print job is suitable to print the user's personal job document according to the print settings received at step 406. The print job may or may not comprise the actual graphical data to be printed. In some embodiments the print job may instead contain references to the graphical data to be printed.

At step 412, the PS Web content 136 initiates printing by causing the print job to be transmitted to the printer 106 via the network 110. At step 414, the PS Web content 136 operates to query the printer to determine the present status of the print job and to determine if the printer has encountered an alert condition. The printer 106 is responsive to the query by returning the requested information. Alternatively, although not explicitly depicted in FIG. 4, the PS Web content 136 could register for status events rather than periodically polling for status. In some implementations, this may reduce network traffic while increasing responsiveness.

The PS Web content 136 receives the response from the printer 106 at step 416. The PS Web content 136 evaluates the response in order to determine if the printer 106 has encountered an alert condition (decision step 418).

If the PS Web content 136 determines that the printer 106 has not encountered an alert condition, the PS Web content 136 operates to display a Web page that indicates the present status of the print job (step 420). For ease of discussion, the Web page displayed at 420 may be referred to herein as the “job status” page. The job status page may provide a user with a wide range of information regarding the present status of the print job. For example, assuming the print job is a multi-copy job, the job status page may indicate the total number of pages presently printed, the number of copies printed, etc.

Next, the PS Web content 136 updates the job status page by periodically repeating steps 414 and 416 in order to obtain the present status of the print job and by periodically updating the job status page with this new information. Alternatively, the PS Web content 136 may be updated by receiving status events directly from printer 106 rather than polling periodically for status as depicted in FIG. 4. The status page may be updated using a variety of techniques including but not limited to polling for status and updating the status web page, receiving status events and updating the status web page, or reloading the status web page periodically from the embedded web server 132.

The PS Web content 136 continues to update the job status page until the print job is successfully printed or the printer 106 encounters an alert condition.

If the PS Web content 136 receives a response at step 416 that indicates the printer 106 has encountered an alert condition, the PS Web content 136 then proceeds to perform steps 424 and step 426.

At step 424, the PS Web content 136 evaluates the printer response to determine the type of alert condition that has occurred. The PS Web content 136 then operates to display a web page that includes a hyperlink (step 426). For ease of discussion, the Web page displayed at step 426 may be referred to herein as the “help page”. The hyperlink that is included in the help page may be referred to herein as the “help link”. As is discussed in greater detail below, the user can select the help link in order to obtain assistance to resolve the printer alert condition that has occurred.

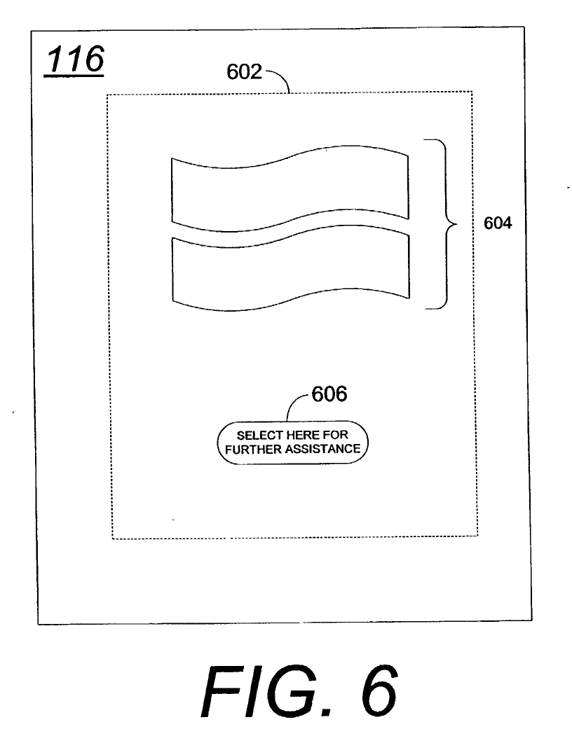

FIG. 6 provides an example of a help page 602 that may be displayed at step 426. As shown, the help page 602 includes a block of text 604 and a help link 606. The block of text 604 may provide the present status of the print job. If the alert condition has resulted in a job failure (i.e., the printer 106 is unable to successfully print the print job), the block of text 604 may provide this information as well.

Additionally, the block of text 604 informs the user that he/she can select the help link 606 in order to obtain additional help to resolve the printer alert condition.

It is noted that the help link may be configured to initiate any number of different functions for assisting the user. For example, a help link may refer to a Web page that includes information that can assist the user. A help link may also be configured to facilitate communication between a user and a specified individual who can provide assistance. For example, the help link may be configured to launch an e-mail dialog box that is pre-addressed for transmission to the system administrator 162. The hyperlink may also be configured to enable voice, data and video collaboration between the user and an individual who can provide assistance. For example, a help link may be configured to initiate a video conference between user (via the client 104) and the administrator 162 (via the admin PC 160). This is assuming, of course, that the client 104 and admin PC 160 include the appropriate resources for establishing such a link. A help link may also be configured to have the system administrator paged.

A help link may also be configured to facilitate the online purchase of certain items from a vendor. In this embodiment, for example, a help link may be configured to facilitate the purchase of items from the vendor Web Site 144.

In this embodiment, the help link that is displayed by the PS Web content 136 at step 426 is dependent upon the type of alert condition detected. Table 1 lists alert conditions types and the corresponding help link that is displayed.

TABLE 1

| Alert condition | Help link | |
|---|---|---|
| Type | Designation | Definition |
| Paper jam | Help link “A” | URL “A” + Parameter String “A” |
| Low toner | Help link “B” | URL “B” + Parameter String “B” |
| Out of print media | Help link “C” | mailto: systemadmin@hp.com |
| All other's | Help Link “D” | URL “A” |

Thus, for example, if the PS Web content 136 detects that the printer 106 has encountered a “paper jam” condition, the PS Web content 136 proceeds to display “help link “A” at step 426. If however, the PS Web content 136 detects that the printer 106 has encountered a low toner condition, then the PS Web content 136 proceeds to display “help link “B” at step 426 and so on.

Help Link “A”

In this example, selecting help link “A” results in a request being transmitted to the Web server 142. The request is addressed to URL “A” and includes the parameter string “A”. Parameter string “A” indicates that the printer 106 has encountered a paper jam condition. The Web server 142 is responsive to the request by returning a Web page. The Web page provides instructions for clearing a paper jam.

Help Link “B”

For Help link “B” it is assumed that the printer 106 is a laser printer that make use of a replaceable toner cartridge that needs to be replaced from time to time. Selecting help link “B” causes the client 104 to transmit a request to the Vendor Web site 144. The request is addressed to URL “B” and includes the parameter string “B”. The parameter string “B” indicates the type of toner cartridge that needs to be ordered. The Vendor Web site 144 is responsive to this request by returning a Web page (purchase page) that enables the user to purchase a replacement toner cartridge. According to one implementation, the Vendor Web site 144 makes use of a “shopping cart” model for permitting online purchases. The purchase page returned to the client 104 shows the replacement cartridge presently in the user's shopping cart. The user can then interact with the purchase page in order to conclude the online purchase of the cartridge.

Help Link C

Selecting help link “C” causes the client 104 to launch an e-mail dialog box that is pre-addressed to the system administrator 162. After selecting help link “C”, the user can interact with e-mail dialog box to transmit an e-mail message to the system administrator 162. The e-mail informs the administrator that he/she should replenish the print media supply. The system administrator can respond to the e-mail by replenishing the print media.

Help Link D

Selecting help link “D” causes a request to be transmitted to the Web server 142. The request is addressed to URL “A”. In this case, however, the request does not include the parameter string “A”. In response to this request, the Web server 142 operates to return a Web page that provides general information regarding how to resolve alert conditions.

Setting Help Links

In this embodiment, the system administrator 162 can define each help link that is displayed for each alert condition. This can be accomplished by use of the HLS content 137.

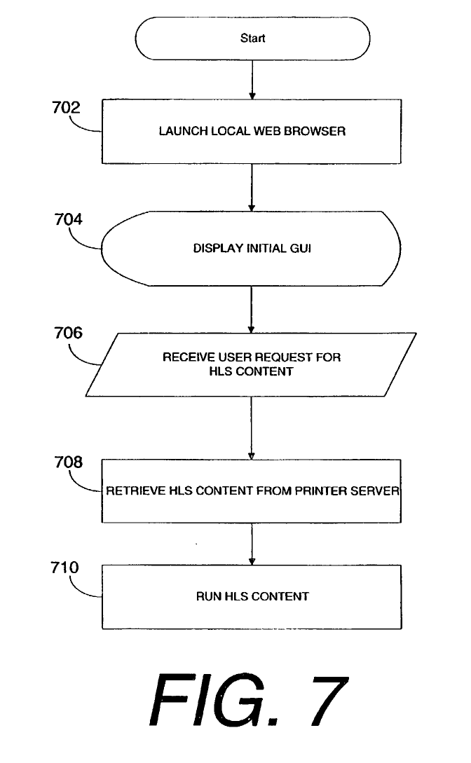

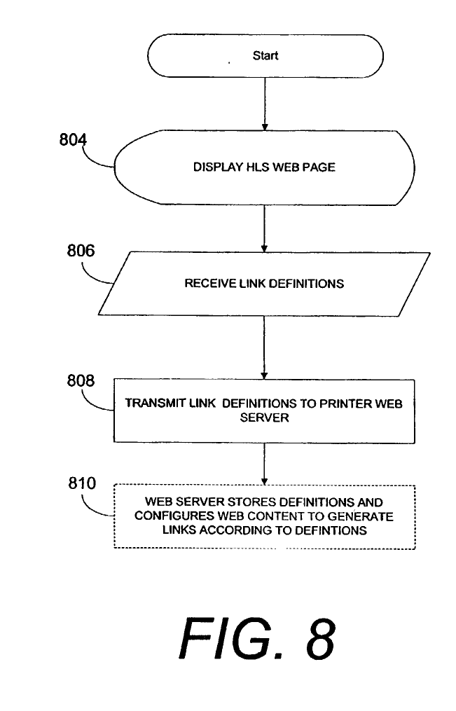

FIG. 7 and FIG. 8 are flow diagrams illustrating how the system administrator 162 can use the admin PC 160 to define a set of help links. Turning now to FIG. 7, the system administrator 162 launches a locally stored Web browser (step 702). Upon being launched, the Web browser displays an initial GUI (step 704).

The administrator can interact with the GUI to request the HLS content 137. The browser receives this request at step 706. In response, the browser retrieves the HLS content 137 (step 708). At step 710, the browser runs the HLS content 137.

FIG. 8 is a flow diagram illustrating the operation of the HLS content 137 at step 710. Turning now to FIG. 8, the HLS content 137 operates to display a GUI (HLS GUI) (step 804). The HLS GUI allows the administrator to define a help link for each alert condition type.

The HLS content 137 receives help link definitions from the administrator at step 806. In response, the HLS content 136 transmits a command to the printer Web server 132 (step 808). The command directs the printer Web server 132 to configure the PS Web content 136 to generate help links according to the definitions received from the system administrator at step 806.

At step 810, the printer Web server 132 responds by storing the system administrator defined definitions and configuring the PS Web content 136 to display links based upon these definitions.

In other embodiments, the HLS content 137 allows the system administrator to define links for specific users. For example, assume it is know that user “A” prefers to have help link “A” displayed (or the administrator prefers this arrangement) when the printer 106 encounters a paper jam condition. User “B”, on the other hand, prefers to have a help link displayed that is configured to establish a video conference (via IP telephony) between him/her and a designated help desk individual who works for the vendor of the printer 106. The following table, Table 2, summarizes these user preferences.

TABLE 2

| Alert condition | | Help link | |
|---|---|---|---|
| Type | User | Designation | Description |
| Paper jam | User “A” | Help link “A” | URL “A” + Parameter |
| | | | String “A” |
| Paper Jam | User “B” | Help link “E” | Establish video |
| | | | conference |

The system administrator can interact with the HLS GUI to establish these user preferences. This information is then sent to the printer Web server 132. The Web server 132 records these preferences and thereafter configures the PS Web content 136 based upon these preferences.

Accordingly, when user “A” logs into the client 104 and requests the PS Web content 136, the request indicates the identity of user “A” in some manner. This may be via a cookie that is sent along with the request. The cookie includes an ID assigned to user “A” from a previous interaction with the website 132. The print server recognizes User “A” (from the cookie which may be subsequently sent with each request to website 132) and returns PS Web content that is configured to display help link “A” when a paper jam condition is detected. When user “B” requests the PS Web content, the printer Web server 132 returns PS Web content that is configured to display help link “E” when a paper jam condition is detected.

It is noted that the Web imaging standard described above represents just one model that enables a user to designate a document that he/she wishes to be accessed by Web based services. There are other models that can be used that also provide a user with this capability. For example, the operation of the client to allow a user to make a job document and to link the job document to Web content may instead be performed by a cooperate effort between various devices. For example, the user may make a job document by interacting with a remote server via his/her personal computer. According to one specific implementation, the remote server (document server) provides a user with a means for selecting a document to be his/her job document. Upon receiving the selection, the document server operates to link the selected document to an identifier (user ID) assigned to the user. The user ID may be the user's login name and password. The user ID is subsequently used to link the Web service to the user selected document. For example, when the user requests access to the service, the service provider (e.g., the printer Web server 132) requests the user input his/her ID. The service provider then makes use of this information to access the user's selected document from the document server. In this manner, therefore, the Web server is able to access the user's pre-selected job document and use that document to synthesize Web content based on that access.

It is important to also note that the present invention may be embodied in the form of a “computer readable medium”. For example, a memory that stores (either temporarily or permanently) the Web content just described may be considered an embodiment of the invention. It is also noted that the phrase “computer readable medium” can refer to any medium that can contain, store or propagate computer readable instructions. Thus, in this context, “computer readable medium” may refer to a medium such as a CD ROM or to signals that are used to communicate the computer readable code over a network, such as the Public Internet. A computer readable medium may also refer to a carrier wave.

Although several specific embodiments of the invention have been described and illustrated, the invention is not to be limited to specific forms or arrangements of parts so described and illustrated. The invention is limited only by the claims and the equivalents thereof.

What is claimed is:

1. A computer implemented method, comprising:
(a) detecting that a printer has encountered an alert condition; and
(b) in response to detecting the alert condition, displaying a user selectable object for initiating a performance by the computer of a specified function for assisting the user in resolving the alert condition.

2. The method of claim 1, wherein the object is a hyperlink.

3. The method of claim 2, further comprising:
(c) initiating the printing of a document by the printer; and
(d) wherein the printer encounters the alert condition while the printer is printing the document.

4. The method of claim 3, wherein the hyperlink refers to a Web page that provides helpful information for resolving the alert condition.

5. The method of claim 3, wherein the function facilitates communication between the user and an individual who can assist in resolving the alert condition.

6. The method of claim 3, wherein the function facilitates transmission of an e-mail by the user to a pre-defined e-mail address.

7. The method of claim 3, wherein the function facilities communication between the user and a specified individual by using voice or broadcast video.

8. The method of claim 3, further comprising:
(e) defining a computer function for assisting a user in resolving an alert condition of a pre-determined type; and
(f) if the detected alert condition is of the pre-determined type, configuring the hyperlink so as to initiate a performance by the computer of the defined function.

9. The method of claim 3, further comprising:
(e) receiving input from a user identifying a computer function for resolving a printer alert condition of a pre-determined type; and
(f) if the detected alert condition is of the pre-determined type, configuring the hyperlink so as to initiate a performance by the computer of the identified function.

10. The method of claim 3, wherein the alert condition indicates a consumable item in the printer should be replaced; and the specified function facilitates a placement of an online order of a replacement consumable item with a vendor.

11. The method of claim 3, wherein the alert condition indicates a toner cartridge in the printer should be replaced; and the specified function facilitates a placement of an online purchase of the toner cartridge with a vendor.

12. The method of claim 3, wherein the alert condition indicates an ink cartridge in the printer should be replaced and the specified function facilitates a placement of an online purchase of the toner cartridge with a vendor.

13. A server, comprising:
(a) means for receiving a request from a client; and
(b) means for responding to the request by transmitting a program of instructions to the client, the program for enabling the client to:
(i) initiate the printing of a document by a printer;
(ii) detect if the printer encounters an alert condition while printing a document; and
(iii) if an alert condition is detected, display a selectable object for initiating a performance by the client of a specified function.

14. The server of claim 13, wherein the object is a hyperlink.

15. The server of claim 14, wherein the function is for assisting a user of the client in resolving the alert condition.

16. The server of claim 14, further comprising:
(c) means for receiving input, from a system administrator, that defines a hyperlink and associates the hyperlink to a particular type of printer alert condition; and wherein the program of instructions is further for enabling the client to display the defined hyperlink if the client detects that the printer has encountered the particular type of alert condition.

17. The server of claim 14, wherein the hyperlink refers to a Web page that provides helpful information for resolving the type of error condition detected.

18. The server of claim 14, wherein the alert condition is a paper jam condition and the hyperlink refers to a Web page that provides information regarding how to clear a paper jam in the printer.

19. The server of claim 14, wherein the alert condition is a low consumable condition and the specified function facilitates the purchase of a replacement consumable.

20. The server of claim 14, wherein the hyperlink is configured to facilitate communication between the client user and a specific individual.

21. The server of claim 13, wherein the server is incorporated within the printer.

22. A computer readable medium embodying a program of instructions for causing a computer to perform method steps, the method steps comprising:
(a) detecting if the printer encounters an alert condition while printing a document; and
(b) displaying a hyperlink referring to a Web object for assisting a user in resolving the particular type of alert condition detected.

23. The computer readable medium of claim 22, wherein the method steps further comprising:
(c) in response to user input, initiating the printing of the document by the printer.

24. The computer readable medium of claim 23, wherein the method steps further comprise:
(d) defining the hyperlink based upon the type of error condition detected.

25. The computer readable medium of claim 22 wherein the Web object is a Web page that provides information for resolving the alert condition.

26. A server, comprising:
apparatus for responding to a pre-defined request received from a client by transmitting a program of instructions to the client, the program for enabling the client to:
(i) detect if the printer encounters an alert condition while printing a document; and
(ii) if an alert condition is detected, display a hyperlink for initiating a performance by the client of a specified function for assisting a user in resolving the alert condition.

27. The server of claim 26, wherein the program further enables the client initiate the printing of the document by the printer.

28. A printing system, comprising:
(a) a printer operable to print a document and to serve a program of instructions to a client;
(b) a client operable by a user to request the program from the printer, the program enabling the client to:
(i) initiate the printing of a document using the printer;
(ii) if the printer encounters an error condition while printing the document, display a hyperlink for initiating a performance by the client of a specified function to assist the client user in resolving the alert condition.

29. The printing system of claim 28, wherein the client is a personal digital assistance (PDA).

30. The printing system of claim 28, wherein the client is a personal computer.

31. The printing system of claim 28, wherein the hyperlink refers to a Web page that provides helpful information for resolving the specific type of error condition encountered by the printer.
